(19) United States
(12) Patent Application Publication
(10) Pub. No.: US 2006/0080142 A1
(43) Pub. Date: Apr. 13, 2006

(54) System for managing patient clinical data

(76) Inventors: Judi Hart, Morgantown, PA (US); Frances Spivak, Hockenssin, DE (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/129,616

(22) Filed: May 13, 2005

Related U.S. Application Data
(60) Provisional application No. 60/617,892, filed on Oct. 12, 2004.

(51) Int. Cl. G06Q 10/00

(52) U.S. Cl. 705/2

(57) ABSTRACT

A system dynamically refreshes stale patient clinical data during a clinical workflow sequence of tasks concerning treatment ordering, patient diagnosis, or patient condition assessment and warns a clinician if patient clinical data has changed since starting a work session. A system for managing patient clinical data includes at least one repository associating sources of clinical data with data representing a form. The form incorporates clinical data derived from the sources. An interface processor automatically interrogates particular sources of clinical data associated with a particular form to identify updated clinical information of a particular patient in response to a user command to process the particular form. An update processor initiates generation of an indication to a user identifying updated clinical information of a particular patient is available prior to processing of the particular form.

This is a non-provisional application of provisional application Ser. No. 60/617,892 by J. Hart et al. filed Oct. 12, 2004.

### FIELD OF THE INVENTION

This invention concerns a system for managing patient clinical data displayed in a form and the update of clinical data in a form used in a healthcare workflow task sequence.

### BACKGROUND OF THE INVENTION

Clinical information is used by multiple different healthcare information systems supporting delivery of healthcare to a patient. Such healthcare information systems include, for example, a clinical information system, patient administration system, laboratory test result system, pharmacy system, admission, discharge and transfer (ADT) administration system, nursing system and dietary system. Such healthcare information systems employ patient clinical data in supporting healthcare workers in performing a sequence of tasks (a workflow) providing treatment to a patient. Existing healthcare information systems typically fail to provide a user with a capability to determine if relevant clinical patient values, such as laboratory results, imaging modality (e.g., MRI, CT, x-ray, ultrasound etc.) information, and vital sign data from patient monitors, have changed between when a task sequence (workflow) supporting patient treatment began and when the task sequence is indicated to be complete. A completed workflow action is indicated by a signing off act, for example. Therefore, a healthcare worker may erroneously indicate a patient treatment workflow task sequence is complete based on non-current data when in fact, the workflow task sequence, if provided with current patient clinical data, indicates additional steps are necessary. Further, manual checking of patient status by a healthcare worker may easily miss relevant data if a paper chart is not current, for example. A system according to invention principles addresses these deficiencies and related problems.

### SUMMARY OF THE INVENTION

The inventors have advantageously recognized that it is desirable to be able to determine if relevant patient values, such as laboratory results, imaging modality information, and vital sign observations from patient monitors, have changed between when a task sequence (workflow) began and when the task sequence is indicated to be completed. A system for managing patient clinical data includes at least one repository associating sources of clinical data with data representing a form. The form incorporates clinical data derived from the sources. An interface processor automatically interrogates particular sources of clinical data associated with a particular form to identify updated clinical information of a particular patient in response to a user command to process the particular form. An update processor initiates generation of an indication to a user identifying updated clinical information of a particular patient is available prior to processing of the particular form.

### BRIEF DESCRIPTION OF THE DRAWING

FIG. 1 shows a system for managing patient clinical and non-clinical data, according to invention principles.

FIG. 2 shows a workflow task sequence involving accessing a form populated with current clinical and non-clinical data of a patient, according to invention principles.

FIG. 3 shows a User Interface (UI) display image used in ordering treatment for a patient and indicating availability of updated clinical data, according to invention principles.

FIG. 4 shows a warning dialog presented in a displayed document such as a document used by a clinician in recording an assessment of a patient medical condition, according to invention principles.

FIG. 5 shows a User Interface (UI) display image form used in entering information concerning an assessment of patient medical Condition and indicating updated patient data, according to invention principles.

FIG. 6 shows a flowchart of a process for managing patient data and enabling population of a form with current clinical and current non-clinical data of a patient, according to invention principles.

### DETAILED DESCRIPTION OF THE INVENTION

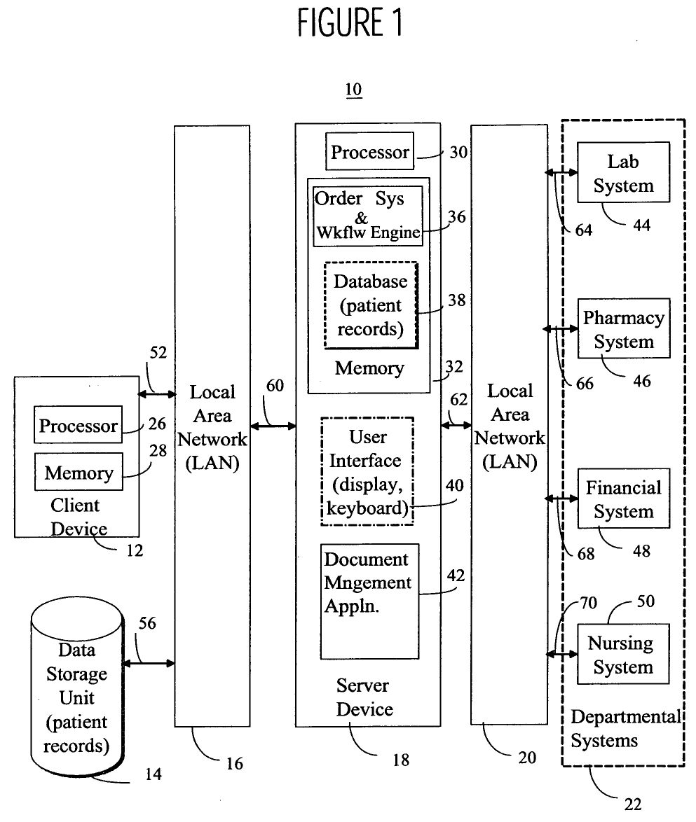

FIG. 1 shows a system for managing patient clinical and non-clinical data. The system dynamically refreshes stale patient clinical data values and highlights previously unrecorded changes, such as critical results and observations, so that a healthcare worker performing a task sequence (workflow) is able to determine a next action to be performed, in response to modified patient clinical data values or other changed patient specific data. The system refreshes stale patient clinical data during a clinical workflow sequence of tasks concerning treatment ordering, patient diagnosis, or patient condition assessment, for example and warns a clinician if patient clinical data has changed since the clinician started a work session. This refresh occurs automatically or on demand and highlights refreshed or changed data items. The refresh occurs either in response to opening an incomplete document or signing off a document as complete, for example. A clinician is able to advantageously use identified updated information to refine and/or change planned actions. This is of particular value in a rapidly changing critical care situation, such as the situations occurring in an emergency department or critical care unit.

Existing systems fail to provide automatic refresh of stale values in response to a healthcare worker opening a document that is in-progress and subject to update and alteration. A system according to invention principles provides a clinician who is involved in an assessment, treatment ordering, and diagnosis task sequence (workflow) with up-to-date patient relevant data to support comprehensive clinical decisions.

The system reduces costly and erroneous medical decisions by displaying the most up to date currently available information whilst clinical data is being charted and also highlights changed values that may be important in the making of a critical decision. A clinician in placing an order for a treatment for a particular patient needs to be aware of patient allergy data, for example. If allergy values change as a result of other evaluations being performed concurrently with an order process workflow, a Dynamic Refresh Values function employed by the system automatically updates patient allergy information within the order processing system at the time a user initiates a command signifying the order is complete. The system further alerts an ordering clinician to verify or double check the order based on new allergy information and the alert is recorded in the patient clinical record.

An executable application as used herein comprises code or machine readable instruction for implementing predetermined functions including those of an operating system, healthcare information system or other information processing system, for example, in response user command or input. An executable procedure is a segment of code (machine readable instruction), sub-routine, or other distinct section of code or portion of an executable application for performing one or more particular processes and may include performing operations on received input parameters (or in response to received input parameters) and provide resulting output parameters. A processor as used herein is a device and/or set of machine-readable instructions for performing tasks. A processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A display processor or generator is a known element comprising electronic circuitry or software or a combination of both for generating display images or portions thereof. A user interface comprises one or more display images enabling user interaction with a processor or other device. A COS is a current order session. A form as used herein is an electronic data representation of a document, record or other structured data compilation that may be rendered into an image, printed document or electronic data for communication. The re-generation of a form as used herein comprises generating data representing the form with changed or updated information elements. A document as used herein as used herein is an electronic data representation of a document, record or other structured data compilation that may be rendered into an image, printed document or electronic data for communication.

FIG. 1 shows a networked hospital information system employing an automated task assignment workflow system 36 and document management application 42 providing an automatic stale data check. Healthcare information system 10 includes a client device 12, a data storage unit 14, a first local area network (LAN) 16, a server device 18, a second local area network (LAN) 20, and departmental systems 22. The client device 12 includes processor 26 and memory unit 28 and may comprise a personal computer, for example. The healthcare information system 10 is used by a healthcare provider that is responsible for monitoring the health and/or welfare of people in its care. Examples of healthcare providers include, without limitation, a hospital, a nursing home, an assisted living care arrangement, a home health care arrangement, a hospice arrangement, a critical care arrangement, a health care clinic, a physical therapy clinic, a chiropractic clinic, and a dental office. Examples of the people being serviced by the healthcare provider include, without limitation, a patient, a resident, and a client.

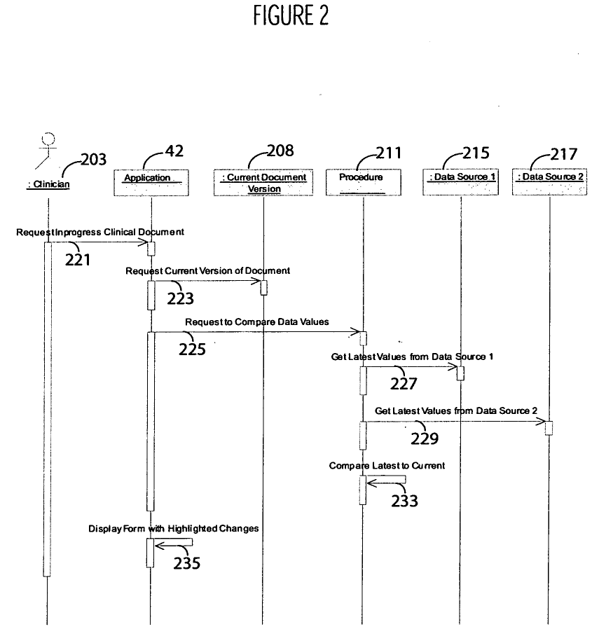

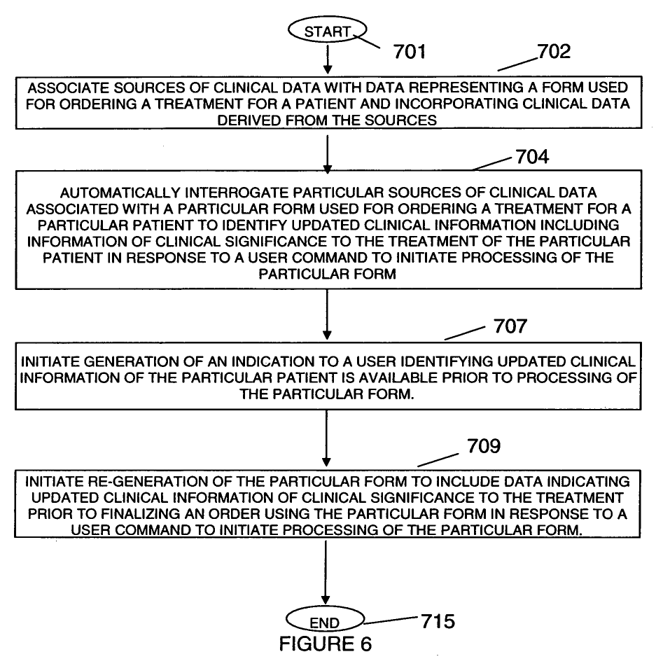

Document management application 42 provides an automatic stale data check on data in documents and forms used in system 10 and supports the processes of FIG. 2 and 6. In another embodiment application 42 is located in client device 12. User interface system 40 (which may also reside in client device 12) includes an input device that permits a user to provide information to client device 12 and an output device that provides a user a display of tabbed menus and other information. Preferably, the input device is a keyboard and mouse, but also may be a touch screen or a microphone with a voice recognition program, or a telephone voice response system for example. The output device is a display, but also may be a speaker, for example. The output device provides information to the user responsive to the input device receiving information from the user or responsive to other activity by client device 12. For example, the display presents information responsive to the user entering information in the client device 12 via a keyboard.

Server device 18 includes processor 30, a memory unit 32 including treatment order system and workflow engine 36 and a database 38 containing patient records. Unit 36 also includes a patient assessment data acquisition and processing application and a clinical data management system. Document management application 42 automatically performs a stale data check on one or more concurrently opened documents (or forms) in response to a user initiating a document save (or open) operation. Application 42 performs a stale data check on documents employed by a treatment order system, a patient assessment system and a clinical data management system in unit 36, for example. Application 42 also performs a stale data check for documents used in healthcare departmental systems 22 that need access to information or provide information related to the health and/or welfare of patients in the care of the healthcare provider. Departmental systems 22 include laboratory system 44, a pharmacy system 46, a financial system 48 and a nursing system 50 and may also include a records system, a patient administration system, a radiology system, an accounting system, a billing system, and any other system required or desired in a healthcare information system.

Server device 18 may be implemented as a personal computer or a workstation. Database 38 provides a location for storing patient records and data storage unit 14 provides an alternate store for patient records, as well as other information for hospital information system 10. The information in data storage unit 14 and database 38 is accessed by multiple users from multiple client devices. Document management application 42 interrogates data sources such as patient records, automatically in response to a user command to access a document or in response to a user storing an edited document or terminating access to a document. Patient records may be accessed from memory unit 28 in client device 12, or in memory units in the departmental systems 22. Patient records in data storage unit 14 include information related to a patient including, without limitation, biographical, financial, clinical, workflow, care plan and patient encounter (visit) related information.

The first local area network (LAN) 16 (FIG. 1) provides a communication network among the client device 12, the data storage unit 14 and the server device 18. The second local area network (LAN) 20 provides a communication network between the server device 18 and the departmental systems 22. The first LAN 16 and the second LAN 20 may be the same or different LANs, depending on the particular network configuration and the particular communication protocols implemented. Alternatively, one or both of the first LAN 16 and the second LAN 20 may be implemented as a wide area network (WAN).

The communication paths 52, 56, 60, 62, 64, 66, 68 and 70 permit the various elements, shown in FIG. 1, to communicate with the first LAN 16 or the second LAN 20. Each of the communication paths 52, 56, 60, 62, 64, 66, 68 and 70 are preferably adapted to use one or more data formats, otherwise called protocols, depending on the type and/or configuration of the various elements in the healthcare information systems 10. Examples of the information system data formats include, without limitation, an RS232 protocol, an Ethernet protocol, a Medical Interface Bus (MIB) compatible protocol, DICOM protocol, an Internet Protocol (I.P.) data format, a local area network (LAN) protocol, a wide area network (WAN) protocol, an IEEE bus compatible protocol, and a Health Level Seven (HL7) protocol.

FIG. 2 shows a workflow task sequence performed using workflow and document (form) management applications 36 and 42 (FIG. 1) respectively involving accessing a document populated with current clinical and non-clinical data of a patient. Application 36 in step 221 communicates a request to document management application 42 to access an in-progress clinical document in response to a command from clinician 203 (FIG. 2). An in-progress clinical document is a document or form that has not yet been finalized and is not in a final state ready for further processing such as a reopened document in the process of editing, for example. Document management application 42 in step 223 acquires a current version of a document 208 and in step 225 initiates a request to executable procedure 211 to compare patient specific data values in the current version of the document with corresponding more recently updated data values available from other data sources.

Executable procedure 211 acquires corresponding more recently updated data values from data source 1 (215) in step 227 and data source 2 (217) in step 229. Executable procedure 211 in step 233 compares patient specific data values in the current version of the document with corresponding more recently updated data values acquired from data source 1 (215) and data source 2 (217) to identify changes. Document management application 42 in step 235 initiates generation of an image display identifying (e.g., by highlighting) changed patient specific data values derived in step 233. Application 42 automatically acquires and displays the latest clinical values derived from data sources not owned by the document type owner (i.e., data managed or accessed via another application). Application 42 highlights the fields which contain the updated values for a user to review.

Document management application 42 accesses data sources providing data used in a clinical document using predetermined information linking available data source and associated access information with an individual document and data fields within the document. Document management application 42 interrogates other data sources automatically in response to a user command to access an “in-progress” document or in response to a user storing an edited document or terminating access to a document.

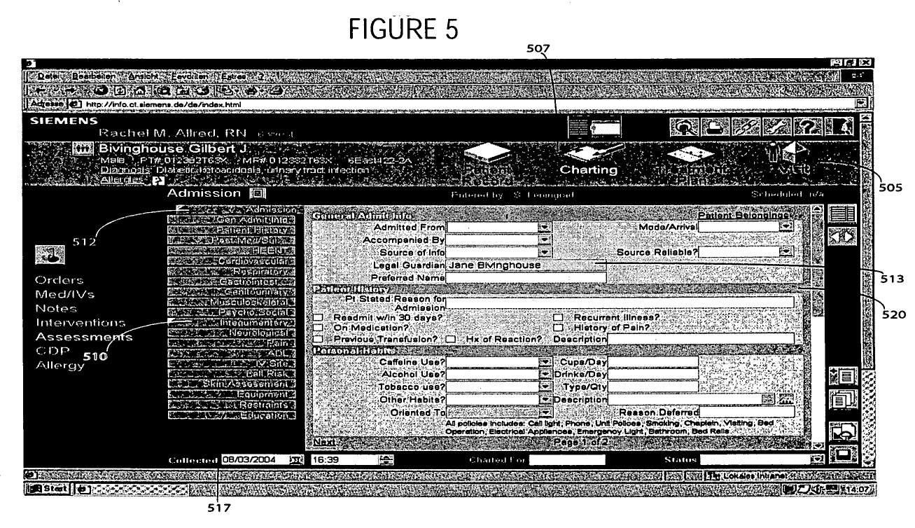

Application 42 highlights document data fields which have been updated. In a user interface image including a tab structure (chapter structure), for example, enabling a user to open multiple documents via tab selection, application 42 updates a tab to include an indicator identifying documents that have fields which have been refreshed (as exemplified by tabs 510 and 512 of FIG. 5). A document that is opened in read-only mode is not updated and data comprising the last saved values is displayed. Document management application 42 automatically performs a stale data check of data displayed within a single page UI document. Application 42 automatically displays a popup dialog requesting a user if the user would like to refresh data items in multiple documents concurrently accessed and displayed in response to user selection of tabs in a tab structure.

Document management application 42 also automatically performs a stale data check on one or more concurrently opened documents in response to a user initiating a document save operation. A save operation occurs upon a user (such as a physician) initiating electronic signing of a document such as an Orders document initiating ordering of a treatment or services for a patient in a displayed current order session (COS) image window, for example. A save operation also occurs upon a user (such as a physician) initiating electronic signing of a patient assessment record made based upon a patient examination or upon signing a variety of other documents. Document management application 42 also automatically determines if updated data is available for data items displayed in a document accessed by a user during another (e.g., previous or concurrent) task sequence workflow. Such updated data may be produced as a result of tasks performed by a healthcare worker in a different second task sequence workflow. Further, if updated data corresponding to displayed data items in the first workflow document is detected, application 42 refreshes the fields in the displayed document with the latest values and highlights the refreshed values.

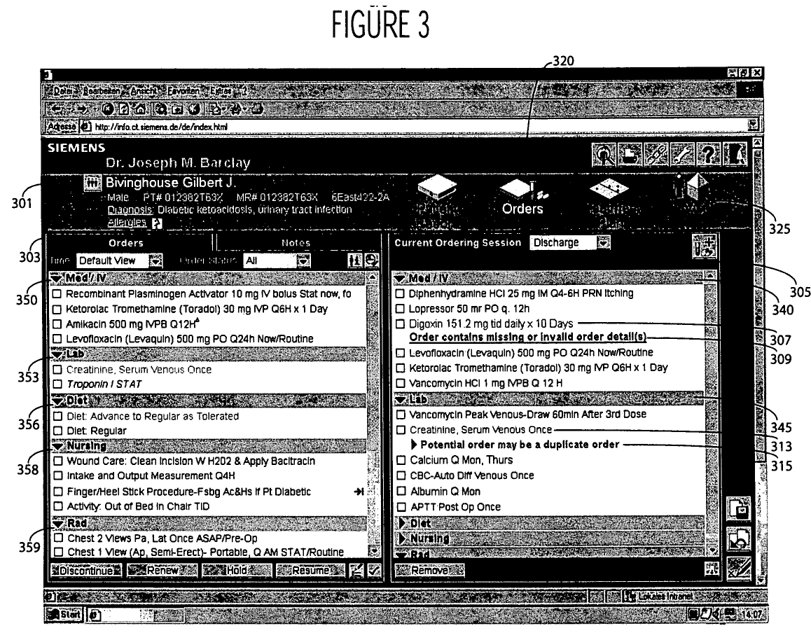

FIG. 3 shows a User Interface (UI) display image used in ordering treatment for a patient and indicating availability of updated clinical data. A patient treatment ordering application is initiated by a clinician via button 320 in row 325. In a patient treatment ordering task sequence workflow being performed by a clinician, document management application 42 determines if updated relevant clinical data is available for data items in a displayed treatment ordering form, in response to a user initiating signing (signifying completion) of an order. Specifically, in response to a clinician initiating signing of an order, application 42 determines if relevant clinical information has changed for a particular patient identified in item 301. The orders previously requested for a particular patient are indicated in image window 303. The requested orders include medication orders 350, laboratory test orders 353, dietary orders 356, nursing orders 358 and radiotherapy orders 359. Image window 305 shows current order session (COS) orders for the patient identified in item 301 selected by a clinician and awaiting signing by the clinician to begin processing of the treatment orders for the patient. The current order session orders include medication orders 340 and laboratory test orders 345.

In response to a user initiating signing of orders selected and displayed in current order session image window 305, application 42 updates image window 305 to include alert and conflict messages under associated orders in the current order session. Specifically, alert message 309 (indicating the order contains missing or invalid order details) is displayed under Digoxin order 307. Also alert message 315 (indicating the order may be a potentially duplicate order) is displayed under Creatinine order 313. Application 42 also may update image window 305 to include an alert message indicating clinically relevant information has been updated by another user. This alert message is presented in image window 305 together with data identifying an associated order and also with other associated conflict messages. Application 42 may require a user to manually open message information and review updated information clinically relevant to an order before permitting a user to sign and initiate processing of the order in the session in window 305.

FIG. 5 shows a User Interface (UI) display image document used in entering information concerning an assessment of patient medical condition and indicating updated patient data. In a patient assessment task sequence workflow being performed by a clinician, document management application 42 determines if updated data is available for data items in a displayed assessment document, in response to a user initiating signing (signifying completion) of the document. Especially, in a case where a clinician is preparing a large assessment document, clinical (and other data) may have changed since a user started preparing assessment documentation. The changed data may significantly affect the assessment. Document management application 42 initiates display of a warning pop up menu in response to a user signing an assessment document and a determination that updated data is available for data items in the document.

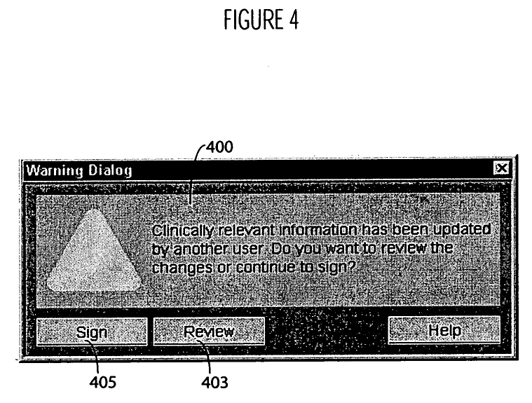

FIG. 4 shows warning dialog 400 presented over a displayed document such as a document shown in FIG. 5 used by a clinician in recording an assessment of a patient medical condition. The dialog informs a user that updated clinical data of a particular patient relevant to an assessment of the patient is available for review via user selection of button 403 or a user may elect to continue with an assessment via selection of button 405. In another embodiment a user is prevented from continuing with an assessment task sequence workflow without first selecting and reviewing the updated data. The updated data is produced in response to actions of another different user performing another task sequence workflow for the same patient, for example.

Application 42 initiates generation of a user interface image supporting patient assessment data capture in response to user selection of charting button 507 in button row 505 of FIG. 5. The patient assessment user interface image includes a tab structure exemplified by the tabs of column 517 of the assessment image of FIG. 5. The tabs enable a user to open multiple documents. Application 42 provides an indicator marking, e.g. a yellow (or other color) portion on a tab (or in a different embodiment another display attribute) as shown in tabs 510 and 512 to indicate available updated data for data items in a document accessed via the marked tab.

In response to a user selecting a marked tab, application 42 displays an assessment document highlighting those data fields that have the updated changed data using a yellow background (or data field highlighted by another display attribute). In response to user selection of admission tab 512, application 42 initiates generation of an assessment document shown in document image window 520. The assessment document indicates changed data in data field 513 (a user entered patient name) by background color highlighting of data field 513. A user is required to view updated data items in assessment document image window 520 before being allowed to proceed with signing the assessment document in order to ensure a user is alerted to any patient safety hazard identified as a result of the updated data. In another embodiment, other display attributes may be used for tab markings or data item highlighting such as, text, color, symbols, shading, icon shape and font alteration, for example. Further, upon a user saving the assessment document including the updated highlighted data items, the marking (e.g., yellow portion) on the associated document tab is removed.

In a clinical data management system, a signed document preserves the format of an adaptable document (form) as well as the values and content of the data in the document at the time of signing the document until the document is “unsigned”. The act of unsigning a document preserves the format of the document but initiates acquisition of the latest values and content of the data in the document. Application 42 automatically highlights updated clinical values prior to the completion and signing of a clinical document or the placing of an order for treatment for a patient.

FIG. 6 shows a flowchart of a process performed by document management application 42 for managing patient data and enabling population of a form with current clinical and non-clinical data of a patient. Such a form may be associated with a patient medical condition assessment or with ordering a treatment for a patient or with clinical data management, for example. Application 42 in step 702 following the start at step 701 associates sources of clinical data with data representing a form used for ordering a treatment for a patient and incorporating clinical data derived from the sources. In step 704 application 42 automatically interrogates particular sources of clinical data associated with a particular form used for ordering a treatment for a particular patient to identify updated clinical information including information of clinical significance to a treatment in response to a user command to initiate processing of the particular form. Application 42 automatically interrogates the particular sources of clinical data using predetermined communication data derived from a repository comprising at least one of, (a) a communication protocol, (b) a data format, (c) a source identifier and (d) a source address. Application 42 uses the communication data in establishing communication with the particular sources of clinical data for automatically interrogating the particular sources.

Application 42 in step 707 initiates generation of an alert indication to a user such as a displayed image feature comprising a pop-up menu, a dialog box, an image window or an option list, for example. The alert indication identifies updated clinical information of a particular patient is available or indicates clinical data has been updated since a user started a work session, prior to processing of the particular form. The indication may comprise a displayed message or indicator prompting a user to initiate re-generation of data representing the particular form to include updated clinical data for the particular patient. Application 42 may also initiate re-generation of data representing a particular form to include data providing a visible indication identifying a clinical data field in the form for which updated clinical data for the particular patient is available. The visible indication may comprises one or more of, highlighting, shading, text emphasis, an added symbol or added text, for example.

In step 709 application 42 initiates re-generation of data representing the particular form to include data indicating updated clinical information of clinical significance to the treatment prior to finalizing an order using the particular form in response to a user command to initiate processing of the particular form. The clinical information of clinical significance to the treatment indicates reevaluation of patient clinical data concerning the treatment is necessary or desirable. In another embodiment it may indicate existence of another order for the treatment or indicate a medical conflict with another treatment already ordered for the particular patient, for example. The user command to process the particular form is initiated during a first workflow task sequence (e.g., a treatment order entry workflow task sequence) being performed by a user. The updated clinical information of a particular patient is generated during a second workflow task sequence (e.g., a patient assessment workflow task sequence) different to the first workflow task sequence. The re-generated particular form includes a visible indication identifying the updated clinical information as being changed since a user started a work session. The visible indication is displayed together with indicators identifying at least one of, an old value of clinical data and a user responsible for providing the updated clinical data.

Document management application 42 is usable by multidisciplinary teams that document and update clinical information about patient care for patients. In one example of operation, a treatment order is placed for a radiology test for Mrs. Smith, who at the time the order was placed, is identified as not being pregnant. When Mrs. Smith goes to the radiology centre, the next day, on displaying the order, the pregnancy indicator is now positive, the results of her pregnancy test coming back that morning. Application 42 alerts a clinician to this change and the clinician is able to confer with a physician to determine whether to proceed with an x-ray or not based on the updated information.

In another example, a patient in an Emergency Room of a hospital is given a blood test. A nurse begins a patient admission assessment and the patient denies any infections, no isolation is indicated for the patient. On finishing the assessment a stale data check is done and the isolation indicator is now positive. The patient blood test has revealed an infection that generated a positive isolation indicator. The nurse is aware of the need to place the patient in isolation. The process of FIG. 6 terminates at step 715.

In other embodiments, application 42 initiates generation of a message in response to a user opening a form which lets the user know which data fields have changed since a last form save. The system also provides Tooltip messages (e.g., in response to a mouse over action) indicating data values that have changed and identifying a user who made the changes. Application 42 also provides a warning message when a form opens to indicate field values have been updated in another workflow task sequence and need to be reviewed. A further warning message is generated by application 42 during a save of a form and indicates that data field values have changed in another workflow since opening form and the fields need to be reviewed. A combination of highlighting and messages are also displayed when a form is opened in read-only mode.

An alternative embodiment employing a workflow or rules engine requires building multiple possible relevant workflow paths. A rules or workflow engine needs to be setup separately from a form building configuration and needs multiple pathways to determine possible data fields that are to be examined upon a command signifying a document is complete. A workflow engine needs to be configured to be aware of locations and data fields that are added to a form and needs to be able to examine associated data values derived from multiple different data sources.

The system and processes presented in FIGS. 1-6 are not exclusive. Other systems and processes may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Further, any of the functions provided by the system of FIG. I and processes of FIGS. 2 and 6 may be implemented in hardware, software or a combination of both. The system is usable in other industries where documentation and/or requests are initiated in dynamic and changing life/death situations, such as police, fire, or terror response call centers where multiple sources are acting on the situation, for example.

What is claimed is:

1. A system for managing patient clinical data, comprising:
at least one repository associating sources of clinical data with data representing a form, said form incorporating clinical data derived from said sources;
an interface processor for automatically interrogating particular sources of clinical data associated with a particular form to identify updated clinical information of a particular patient in response to a user command to process said particular form; and
an update processor for initiating generation of an indication to a user identifying updated clinical information of a particular patient is available prior to processing of said particular form.

2. A system according to claim 1, wherein
said update processor initiates re-generation of data representing said particular form to include data providing a visible indication identifying a clinical data field in said form for which updated clinical data for said particular patient is available.

3. A system according to claim 2, wherein
said update processor initiates generation of data representing a displayed message prompting a user to initiate re-generation of data representing said particular form to include said updated clinical data for said particular patient.

4. A system according to claim 2, wherein
said visible indication identifying said clinical data field in said form for which updated clinical data for said particular patient is available, comprises at least one of, (a) highlighting, (b) shading, (c) text emphasis, (d) an added symbol and (e) added text.

5. A system according to claim 1, wherein
said update processor initiates re-generation of data representing said particular form to include updated clinical data for said particular patient together with a visible indication identifying said updated clinical data as being changed since a user started a work session.

6. A system according to claim 1, wherein
said update processor initiates generation of data representing a displayed image feature indicating updated clinical data for said particular patient is available.

7. A system according to claim 6, wherein
said displayed image feature identifies said updated clinical data as being changed since a user started a work session

8. A system according to claim 1, wherein
said displayed image feature comprises at least one of, (a) a pop-up menu, (b) a dialog box, (c) an image window and (d) an option list.

9. A system according to claim 1, wherein
said at least one repository incorporates communication data enabling communication with said associated sources of clinical data and
said interface processor uses said communication data in establishing communication with said particular sources of clinical data for automatically interrogating said particular sources.

10. A system according to claim 1, wherein
said interface processor automatically interrogates said particular sources of clinical data using predetermined communication data derived from a repository comprising at least one of, (a) a communication protocol, (b) a data format, (c) a source identifier and (d) a source address.

11. A system according to claim 1, wherein
said update processor initiates re-generation of data representing said particular form to include updated clinical data for said particular patient together with a visible indication identifying said updated clinical data as being changed and indicators identifying at least one of, (a) an old value of clinical data and (b) a user responsible for providing said updated clinical data.

12. A system according to claim 1, wherein
said user command to process said particular form is initiated during a first workflow task sequence being performed by a user; and
said update processor initiates generation of data representing a message to a user identifying updated clinical information of a particular patient, said updated clinical information being generated during a second workflow task sequence different to said first.

13. A system according to claim 1, wherein
said particular form a patient medical condition assessment related form.

14. A system for ordering a patient treatment, comprising:
at least one repository associating sources of clinical data with data representing a form used for ordering a treatment for a patient, said form incorporating clinical data derived from said sources;
an interface processor for automatically interrogating particular sources of clinical data associated with a particular form used for ordering a treatment for a particular patient to identify updated clinical information of clinical significance to said treatment in response to a user command to initiate processing of said particular form; and
an update processor for initiating re-generation of said particular form to include data indicating updated clinical information of clinical significance to said treatment prior to finalizing an order using said particular form in response to a user command to initiate processing of said particular form.

15. A system according to claim 14, wherein
said clinical information of clinical significance to said treatment indicates existence of another order for said treatment.

16. A system according to claim 14, wherein
said clinical information of clinical significance to said treatment indicates a medical conflict with another treatment already ordered for said particular patient.

17. A system according to claim 14, wherein
said user command to initiate processing of said particular form is initiated during a treatment order entry workflow task sequence being performed by a user; and
said updated clinical information of clinical significance to said treatment is generated during another workflow task sequence different to said treatment order entry workflow task sequence.

18. A method for managing patient clinical data, comprising the activities of:
associating sources of clinical data with data representing a form, said form incorporating clinical data derived from said sources;
automatically interrogating particular sources of clinical data associated with a particular form to identify updated clinical information of a particular patient in response to a user command to process said particular form; and
initiating generation of an indication to a user identifying updated clinical information of a particular patient is available prior to processing of said particular form.

19. A method for ordering a patient treatment, comprising the activities of:
associating sources of clinical data with data representing a form used for ordering a treatment for a patient, said form incorporating clinical data derived from said sources;
automatically interrogating particular sources of clinical data associated with a particular form used for ordering a treatment for a particular patient to identify updated clinical information of clinical significance to said treatment in response to a user command to initiate processing of said particular form; and
initiating re-generation of said particular form to include data indicating updated clinical information of clinical significance to said treatment prior to finalizing an order using said particular form in response to a user command to initiate processing of said particular form.
